(19) United States
(12) Patent Application Publication
(10) Pub. No.: US 2025/0376383 A1
(43) Pub. Date: Dec. 11, 2025

(54) LITHIUM EXTRACTION FROM NATURAL BRINES BY ADVANCED CARBONATION PROCESSING

(71) Applicants: Jinichiro Nakano, Albany, OR (US); Anna Nakano, Albany, OR (US)

(72) Inventors: Jinichiro Nakano, Albany, OR (US); Anna Nakano, Albany, OR (US)

(21) Appl. No.: 18/738,054

(22) Filed: Jun. 9, 2024

Related U.S. Application Data
(63) Continuation-in-part of application No. 18/738,049, filed on Jun. 9, 2024.

(51) Int. Cl. C01D 15/08

(52) U.S. Cl. CPC C01D 15/08

(57) ABSTRACT

A low capital and environmentally friendly process of extracting lithium from natural brines. The method includes adjusting a unique parameter defined based on the modified alkalinity in a quantity of the natural brine to a preset value independent of the pH. Interactions of the anionic reactant species with lithium within the natural brine cause a solid form of the material that then precipitates out of the natural brine. After the solid separation, the spent brine may be returned to underground or transported to a reservoir.

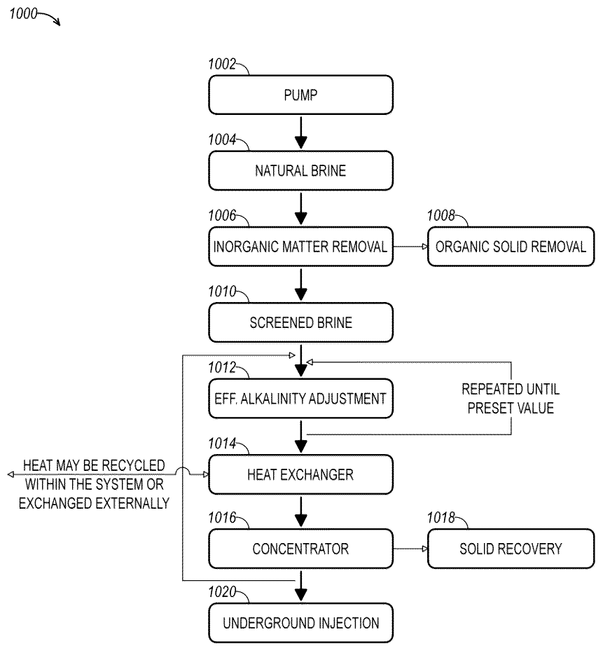

### BACKGROUND OF THE INVENTION

This invention is directed to a process for extracting lithium and forming lithium carbonate from natural brines without requiring post-carbonation steps. The lithium is extracted through advanced carbonation processing by adjusting a unique parameter determined based on the modified alkalinity of the brine to a preset value and recovering the lithium as a precipitate. The precipitate is formed through direct and indirect interactions of the available anionic species with the lithium in the natural brine and its surroundings.

The process described herein is a rapid, economical, and environmentally friendly extraction of lithium from natural brines. Natural brines are, in general, naturally occurring bodies of water with certain concentrations of dissolved constituents—elements, ions, and molecules. Brines are commonly considered to be those waters more saline or more concentrated in dissolved materials than seawater (35 grams of dissolved constituents per kilogram of seawater). Natural brines can contain salt (sodium chloride) in concentrations more than five times greater than the salt content of average seawater. Natural brine herein means naturally occurring brines except for all of the following: seawater and geothermal brines, brines produced as a co-product, by-product, or waste stream from industrial practices or energy production/development such as geothermal power plants, oil & gas production, carbon sequestration, enhanced oil recovery, and coal bed methane recovery, and brines produced in association with abandoned mine land (hereinafter, in this disclosure, “Brine”).

The invention enables rapid, economical, and environmentally friendly extraction of lithium, which is accomplished through mineralization of the Brine by adjusting the effective alkalinity of the Brine. The adjustment of the effective alkalinity of the Brine using the process described herein causes carbonation to generate lithium carbonate (Li₂CO₃) from the Brine. In particular, the process generates the final product directly from the Brine without requiring a pre-concentration step such as evaporation ponds and direct lithium extraction (DLE).

Currently, the extraction of lithium from brines is conducted in two steps: first through the lithium concentration step, which is performed by an evaporation pond route or DLE techniques, followed by carbonation steps typically at separate facilities.

While CO₂ acidifies water (i.e., lowers the pH), carbonation by advanced CO₂ gas injection into the liquid medium has been suggested in the past few decades by academia and industries for extraction of a variety of metals from liquid media. For this approach to be practically effective, the process has been enhanced by thermodynamic manipulations, for example, pH modification via co-utilization of solid additives or operation under supercritical conditions. The use of microbubbles having a diameter of 50 microns or less was suggested in conjunction with solid additives to promote the carbonation of a liquid to extract metals. The advanced injection of nanobubbles (<1 micron) of gases such as carbon dioxide, ozone, oxygen, air, and nitrogen has been suggested and widely practiced in the past few decades in industries such as materials, agriculture, fishery, medical, pharmaceutical, environmental, biological, cleaning, and sanitation because nanobubbles can adjust the pH or improve the solubility limits (i.e., concentrations) of dissolved gas, the population of suspended gas (e.g., non-dissolved), the surface energy of trapped gas, the surface tension of liquid, wettability, and the charges (e.g., zeta potential) in the vicinity of the trapped gas, while providing the ability to be suspended in a liquid medium for an extended period of time (months to years). Because of such wide applications and uses, various advanced techniques for generating nanobubbles and their injection are commercially available.

By effective alkalinity adjustment of the Brine, lithium extraction occurs substantially instantaneously because the process extracts lithium from the Brine in the form of a mineral directly in the source Brine. Thus, no subsequent mineralization facility is needed for the system and process. Consequently, the present invention effectively eliminates the need for transporting materials from a mining site or concentrates (or eluates) from a concentration site to a mineralization facility. This significantly reduces economic and environmental burdens (limited production rates, local water consumption, fuel consumption, CO₂ emissions, etc.) in the extraction process. It is also envisioned that operation expenses of giga/mega factories for battery manufacturing would be enhanced if they were operated at the source of lithium extraction. Thus, as disclosed herein, it is useful in the art to provide a low capital and environmentally friendly process of extracting lithium from Brine.

### BRIEF SUMMARY OF THE INVENTION

The method includes selecting and adjusting effective alkalinity determined based on the modified alkalinity in a quantity of Brine to a preset value. Alkalinity, in general, is a measurement of dissolved alkaline substances that may represent a Brine's capacity or ability to neutralize acids so that the pH does not abruptly change. The effective alkalinity, as defined in this disclosure, is used to activate existing anions and cations to cause a new state of equilibrium (or metastable equilibrium) in the Brine to enable precipitation of the lithium without needing to purposefully modify the pH of the Brine.

Alkalinity, in general, may be expressed in units of concentration. For the purpose of this disclosure, concentrations of the following species are considered in the effective alkalinity determination, which may be as an individual, a combination, or a total: carbonate and other carbonic species (e.g., CaCO₃, CaMg(CO₃)₂, CO₃²⁻, HCO₃⁻); silicate and other silicon species (e.g., SiO₂, SiO(OH)₃⁻); borate and other boron species (e.g., B(OH)₄⁻); hydroxide species (e.g., OH⁻); and chlorine species (e.g., HOCl, HCl). In some embodiments, alkalinity is modified, which is a partial total alkalinity defined in this disclosure as the balanced concentrations: [HCO₃⁻]+2[CO₃²⁻]+[CaCO₃]+[CaMg(CO₃)₂]+[B(OH)₄⁻]+[OH⁻]+[SiO(OH)₃⁻]+[NH₃]−[H⁺]−[HF]−[HOCl]−[HCl].

The effective alkalinity (A_{eff}) in this disclosure is defined as: {(the alkalinity of a liquid)+(protonation donors)}/{(the sum of concentrations of anions with charges of 2− or higher)+(the sum of concentrations of dissolved species in the liquid)}.

In some embodiments, the effective alkalinity may be simplified as the ratio of the alkalinity to the concentration of dissolved species.

In one embodiment, the preset effective alkalinity is in the range of 0.022-13.055. In another embodiment, the preset effective alkalinity is in the range of 0.062-10.05. In another embodiment, the preset effective alkalinity is in the range of 0.11-8.57.

The effective alkalinity expressed this way can effectively enable the determination of desired carbonation for lithium. A non-limited example includes:

$${A}_{eff} = \{ {( [ {HCO}_{3}^{-} ] + 2 [ {CO}_{3}^{2 -} ] + [ {CaCO}_{3} ] + [ {CaMg ( {CO}_{3} )}_{2} ] + [ B ( OH )}_{4}^{-} ] + [ {OH}^{-} ] + [ SiO {( OH )}_{3}^{-} ] - [ {H}^{+} ] - [ HF ] ) - [ HOCl ] - [ HCl ] ) + ( [ {H}^{+} ] ) \} / \{ ( 2 [ {CO}_{3}^{2 -} ] ) + ( {CaCO}_{3} + CaMg {( {CO}_{3} )}_{2} + {SiO}_{2} + {CO}_{x} + {O}_{x} + {C}_{x} {H}_{y} ) \} \qquad Eq . 1$$

Note the total alkalinity component in this equation, if charges and protons are balanced, should not be affected by the pH, temperature, and pressure.

When the effective alkalinity is optimally adjusted, the following exemplified elemental reaction for lithium carbonation is expected:

$$2 {Li}^{+} + {C}^{4 +} + 3 {O}^{2 -} = {Li}_{2} {CO}_{3} \qquad Eq . 2$$

Non-limiting resource examples for Li⁺ may include Li ions, LiCl, LiOH, LiOH·H₂O, Li₂CO₃, Li₂O, and lithium-bearing minerals. Non-limiting resource examples for C⁴⁺ may include carbonic species, carbonates, air, and trapped air. Non-limiting resource examples for O²⁻ may include carbonic species, carbonates, oxygen-bearing ions, oxygen-bearing compounds, dissolved oxygen, air, and trapped air.

The effective alkalinity adjustment is performed by controlling concentrations of species mentioned in [0009] and by [0013] any known means or chemical reactions induced by, for example, carbonation and decarbonization.

Carbonation and decarbonization can be conducted with the carbonic species, which may originate from, produced by, or controlled by interactions with carbonic solids, gases, and liquids, or those containing carbonic species such as alkali carbonates, ultrafine gaseous carbonic spheroids having a diameter of ≤999 nanometers, dissolved carbonic gases, and respective ions. The carbonic species may be removed by any existing means, such as flotation and known chemical reactions.

### BRIEF DESCRIPTION OF THE DRAWINGS

A process flow diagram of the invention.

### DETAILED DESCRIPTION OF THE INVENTION

The disclosed process will become better understood by reviewing the following detailed description in conjunction with the figure. The detailed description and the figure provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

The overall process and preferred embodiment (1000) is illustrated in the figure. The process illustrated in the figure can be operated either as a batch or a continuous process. The Brine (1004) is fed to the process (1000) by pumping (1002) the Brine (1004) from its source; hydraulic pressure of the Brine from underground may be utilized to move the liquid medium through the process. Alternatively, the hydraulic pressure is converted to energy to be utilized in the process or stored for later use. Inorganic and organic matter (1006 and 1008, respectively) are removed using a wire mesh screen, filters, perforated metal plate, osmosis, ionization, electrolysis, flotation, or any other method known in the art to provide the screened Brine (1010). In one embodiment, inorganic matter is removed before organic matter. In another embodiment, the brine is screened to remove organic matter before inorganic matter. Next, the effective alkalinity (A_{eff}) in the screened Brine (1010) is adjusted toward a preset value (1012), which may be repeated until a preset value is obtained.

In one embodiment, a preset value for the effective alkalinity is determined so that a total mass of available carbonic species (ionic, aqueous, and dissolved) in brine is equal to or higher than that determined by the stoichiometry of the final product. In the first embodiment, the preferred alkalinity is in the range of 2-200 mg/L CaCO₃. In the second embodiment, alkalinity in a range of 100 to 500 mg/L CaCO₃ is more preferred. In the third embodiment, alkalinity is the most preferred range of 300 to 1,000 mg/L CaCO₃.

The Brine then goes to a heat exchanger, where heat is exchanged within the system or externally to adjust the temperature of the Brine to a preset value (1014). The lithium in the Brine with the adjusted effective alkalinity reacts with the anions and precipitates as solid Li₂CO₃. In some embodiments, the anions are available in the Brine and surroundings. The brine with the precipitates undergoes a precipitate (ppt.) concentrator to concentrate Li₂CO₃ materials (1016) and separated at (1018). Concentration and separation can be performed by any conventional means, including gravitational, density, centrifuge, flotation, filtration, charge, surface tension, membrane, screening, absorption, adsorption, and electrostatic. The brine after solid separation may be returned to the main stream before (1012). The spent Brine after (1016) may be injected back underground (1020) or transported to a reservoir or other storage units.

### DEFINITIONS

The following definition applies herein, unless otherwise indicated. For the purposes of this disclosure, carbonic species or reactant carbonic species includes: aqueous species with non-limiting examples including carbonic acid, bicarbonate, and carbonate; gaseous species such as carbon monoxide, carbon dioxide, and hydrocarbons; dissolved gaseous species; anionic forms of gaseous species; cationic forms of gaseous species; and protonated and deprotonated forms of gaseous species.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and sub-combinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and sub-combinations of the disclosed inventions that are believed to be novel and non-obvious. Inventions embodied in other combinations and sub-combinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method for extracting lithium from natural brines comprising:
providing a natural brine;
adjusting the effective alkalinity in the natural brine to a preset value using at least one effective alkalinity adjustment step;
precipitating the lithium from the natural brine; and
exchanging heat with the natural brine using at least one heat exchanger step.

2. The method of claim 1, where the method further comprises:
concentrating the lithium precipitate using at least one precipitate concentration step;
separating the lithium precipitate; and
exiting the spent natural brine from the system.

3. The method of claim 1, where the effective alkalinity is the ratio of the alkalinity to the concentration of dissolved species.

4. The method of claim 1, where the preset effective alkalinity is in the range of 0.022-13.055.

5. The method of claim 1, where the preset effective alkalinity is in the range of 0.062-10.05.

6. The method of claim 1, where the preset effective alkalinity is in the range of 0.11-8.57.

7. The method of claim 1, wherein adjusting the effective alkalinity is preceded by selecting the reactant species for lithium to be recovered.

8. The method of claim 1, further comprising screening the brine prior to adjustment of the effective alkalinity.

9. The method of claim 1, where the precipitated lithium is lithium carbonate.

10. The method of claim 1, where the spent brine is returned to the mainstream and mixed at a preset ratio before the effective alkalinity adjustment step.

11. A method for extracting lithium from natural brines comprising:
providing a natural brine;
adjusting the effective alkalinity in the natural brine to a preset value using at least one effective alkalinity adjustment step;
precipitating the lithium from the natural brine;
exchanging heat with the natural brine using at least one heat exchanger step;
concentrating the lithium precipitate using at least one precipitate concentration step;
separating the lithium precipitate; and
exiting the spent natural brine from the system.

12. The method of claim 11, where the preset effective alkalinity is in the range of 0.022-13.055.

13. The method of claim 11, where the preset effective alkalinity is in the range of 0.062-10.05.

14. The method of claim 11, where the preset effective alkalinity is in the range of 0.11-8.57.

15. A method for extracting lithium from natural brines comprising:
providing a natural brine;
screening the brine;
adjusting the effective alkalinity in the natural brine to a preset value using at least one effective alkalinity adjustment step;
precipitating the lithium from the natural brine;
exchanging heat with the natural brine using at least one heat exchanger step;
concentrating the lithium precipitate using at least one precipitate concentration step;
separating the lithium precipitate; and
exiting the spent natural brine from the system.

16. The method of claim 15, where the preset effective alkalinity is in the range of 0.022-13.055.

17. The method of claim 15, where the preset effective alkalinity is in the range of 0.062-10.05.

18. The method of claim 15, where the preset effective alkalinity is in the range of 0.11-8.57.
